(19) United States
(12) Patent Application Publication
(10) Pub. No.: US 2011/0048890 A1
(43) Pub. Date: Mar. 3, 2011

(54) EQUIPMENT FOR THE AUTOMATIC DEPOSIT AND WITHDRAWAL OF BANKNOTES AND RESPECTIVE RECEIPTING AND DISPENSING MODULES

(75) Inventors: Mirko Billet, Bollengo (IT); Mauro Martinotti, Bollengo (IT); Mario Perino, Bollengo (IT); Renato Bortolin, Bollengo (IT); Carlo Simonotti, Bollengo (IT); Ivan Ferrero Aprato, Bollengo (IT)

(73) Assignee: CTS CASHPRO S.P.A., Bollengo (IT)

(21) Appl. No.: 12/681,239

(22) PCT Filed: Oct. 1, 2008
(86) PCT No.: PCT/IB08/54536

§ 371 Date: May 12, 2010

(30) Foreign Application Priority Data
Oct. 12, 2007 (IT) TO2007A000721

(51) Int. Cl. G07F 7/04

(52) U.S. Cl. 194/206

(57) ABSTRACT

Equipment for the automatic deposit and withdrawal of banknotes (31) comprising a store safe (36) and a series of banknote receipting and dispensing modules or boxes (32-1, 32-2, . . . 32-N), and in which each module comprises a collecting seat (78) and an insertion and extraction device (79) for the banknotes. The receipting and dispensing modules or boxes are mounted with individual possibility of shifting in the store safe between an internal operative position and an external service position. At least one of the receipting and dispensing modules (32n) is a removable module and includes a container or recycling cartridge (111). The recycling container is removable and is assemblable with respect to the insertion and extraction device (79) in the position of service of the module and defines the collecting seat for lodging a stack (83), with arrangement of the banknotes (83) substantially in vertical.

### FIELD OF THE INVENTION

The present invention relates to an equipment for the automatic deposit and withdrawal of banknotes and respective receipting and dispensing modules.

More specifically, the invention relates to an equipment for the deposit and the withdrawal of banknotes comprising a series of banknote receipting and dispensing modules or boxes according to the introductive portions of the main claims.

### BACKGROUND OF THE INVENTION

Equipments of this type are used in banking sites as help for tellers or as “self service” equipments operable by customers, without assistance, for banking transactions comprising the cash-in and the withdrawal of cashes. The modules or boxes or portions of the receipting and dispensing modules have function of recycling of the banknotes and are generally removable from the equipment for the loading or the emptying or for other control operations. In modules having high storing capacity and limited dimensions, the banknotes are stored so as to define a stack of banknotes with horizontal extension and support on the longer edge.

The operations of loading or emptying of banknote receipting and dispensing modules are entrusted to authorized personnel, often different from the tellers and transport of the modules in sites different from the site of installation of the equipment. These operations require rather long overall times. It has as a result that, for ensuring continuity of service, a sufficient number of spare modules associated to a given equipment is necessary. Naturally, high reliability and great safety are required to the modules, both in the operation, and in the operations of loading or emptying. Moreover, it is also necessary to ensure that effractions or operations not authorized on the same modules are prevented and that, anyway, these operations are easily recognizable.

In the equipments for the automatic deposit and withdrawal of the banknotes and recycling functions of known type, the receipting or dispensing modules or boxes generally have, on board, the moving mechanisms necessary for executing the introduction and the extraction of the banknotes, with separation from the respective stacks. Thus, the modules result rather complex and expensive. Therefore, taking into account of the spare modules or boxes of the equipment, the overall cost of an installation with an equipment for the automatic deposit and withdrawal of banknotes results rather high. Moreover, the weight of the structure and of the respective mechanisms of the module is high and requires a relevant physical effort to the operators, in the mounting or removal operations, when the module or box is full.

### SUMMARY OF THE INVENTION

An object of the invention is to accomplish an equipment for the automatic deposit and withdrawal of banknotes and respective receipting or dispensing modules or boxes which result reliable, of relatively contained cost, of easy use in the connected operations to the modules, and ensuring high operative safety.

According to a characteristic of the present invention, the equipment for the automatic deposit and withdrawal of banknotes comprises a store safe and a series of banknotes receipting and dispensing modules or boxes and in which each module comprises a collecting seat and an insertion and extraction device for the banknotes. The receipting and dispensing modules or boxes are mounted with individual possibility of shifting in the store safe between an internal operative position and an external service position and in which at least one of the modules or boxes is a removable module and comprises a recycling container. The recycling container is removable and is assemblable with respect to the insertion and extraction device, in the service position of the module, and it defines the receipting seat for lodging a stack with arrangement of the banknotes substantially in vertical.

According to another characteristic, the equipment for the automatic deposit and withdrawal of banknotes comprises a store safe with a series of banknote receipting and dispensing modules or boxes, a store transport mechanism for moving the banknotes from the modules and toward the modules and in which the banknotes receipting and dispensing modules or boxes are arranged overlapped in the store safe, with possibility of individually sliding, for service, on substantially horizontal sliding surfaces. Each module comprises a banknotes collecting seat, for lodging a stack of banknotes with arrangement in vertical, and an insertion and extraction device. The transport mechanism has a substantially vertical path and has diverting members for the banknotes in insertion and extraction. The transport mechanism has sections associated with the single modules with possibility of individual opening and closing, and in which the associated sections of the transport mechanism are mounted on the modules and are moving, for service, together with the same modules.

Modules or boxes for the automatic processing of banknotes are known, in which the banknotes are lodged in removable containers or cartridges, having only the function of store for the deposit. These modules do not respond therefore to the requirements for the recycling of banknotes.

Equipments with functional groups for the automatic processing of banknotes and having recycling containers for the banknotes have also been proposed. These containers have also the possibility of removal. Nevertheless the proposed solutions are complex and of questionable reliability.

Another object of the invention is to accomplish a receipting or dispensing module or box for equipments for the automatic deposit and withdrawal of banknotes and respective containers or cartridges for the banknotes, which result reliable, of relatively contained cost, which ensure great operative safety and in which the operations on the modules are easy.

According to a further characteristic, the banknotes receipting and dispensing modules or boxes are employable in an equipment for the deposit and the withdrawal of banknotes and comprise each one an insertion and extraction device for banknotes, a base structure and a container or cartridge, of recycling for the banknotes, mountable and removable manually with respect to the base structure, having vertical arrangement of the banknotes, support on a longer edge and formation of a respective stack. The recycling container defines an area of access to a terminal surface of the stack of banknotes and comprises an element of opening-closing for the area of access and an access command mechanism for the element of opening-closing and in which, when the container is mounted on the base structure, the area of access to the stack of banknotes is functional to the insertion and extraction device for inserting and extracting the banknotes with respect to the terminal surface of the stack. The receipting and dispensing module includes an actuation and/or command element or actuation and/or command elements, operative on the access command mechanism for causing the area of access to be opened in association with the mounting of the container in the base structure and for causing the area of access to be closed in condition of removed container.

### BRIEF DESCRIPTION OF THE DRAWINGS

The characteristics of the invention will become clear by the following description given purely by way of non-limiting example, with reference to the appended drawings in which:

FIG. 1 represents a schematic lateral view of an equipment for the automatic deposit and withdrawal of banknotes and respective receipting or dispensing modules or boxes, according to the invention, in a condition of use;

FIG. 2 is a schematic lateral view of the equipment and the receipting and dispensing modules according to the invention, in a service condition;

FIG. 3 shows a schematic perspective view, partially exploded, of a banknotes receipting and dispensing module or box with a container or recycling cartridge, according to the invention;

FIG. 4 represents a schematic lateral section of a banknotes receipting and dispensing module and of a recycling container of the invention in a pre-assembling condition;

FIG. 4a shows some details of the container of FIG. 4;

FIGS. 5, 6 and 7 represent the banknotes receipting and dispensing module of the invention in different conditions;

FIG. 8 shows some details, in an enlarged scale, of the banknotes receipting and dispensing module in a service condition;

FIG. 9 shows some details, in an enlarged scale, of the equipment of FIGS. 1 and 2 and of a respective module;

FIG. 10 represents a front perspective view of a recycling container for a banknotes receipting and dispensing module according to the invention;

FIG. 11 is a back perspective view of the recycling container of FIG. 10;

FIG. 12 represents a schematic perspective view, partially exploded, of some details of the recycling container of FIG. 10;

FIG. 13 is another schematic perspective view of some details of the container of FIG. 10;

FIG. 14 is a schematic lateral view of a recycling container according to the invention, in a condition of service;

FIG. 15 is a schematic front view of the container of FIG. 14;

FIGS. 16, 16a, 16b and 16c represent some details of the recycling container of FIG. 10, in different operative conditions; and

FIGS. 17 and 18 are partial and schematic lateral views of a variant of the equipment and of modules or boxes according to the invention.

### DETAILED DESCRIPTION OF THE PREFERRED EMBODIMENTS

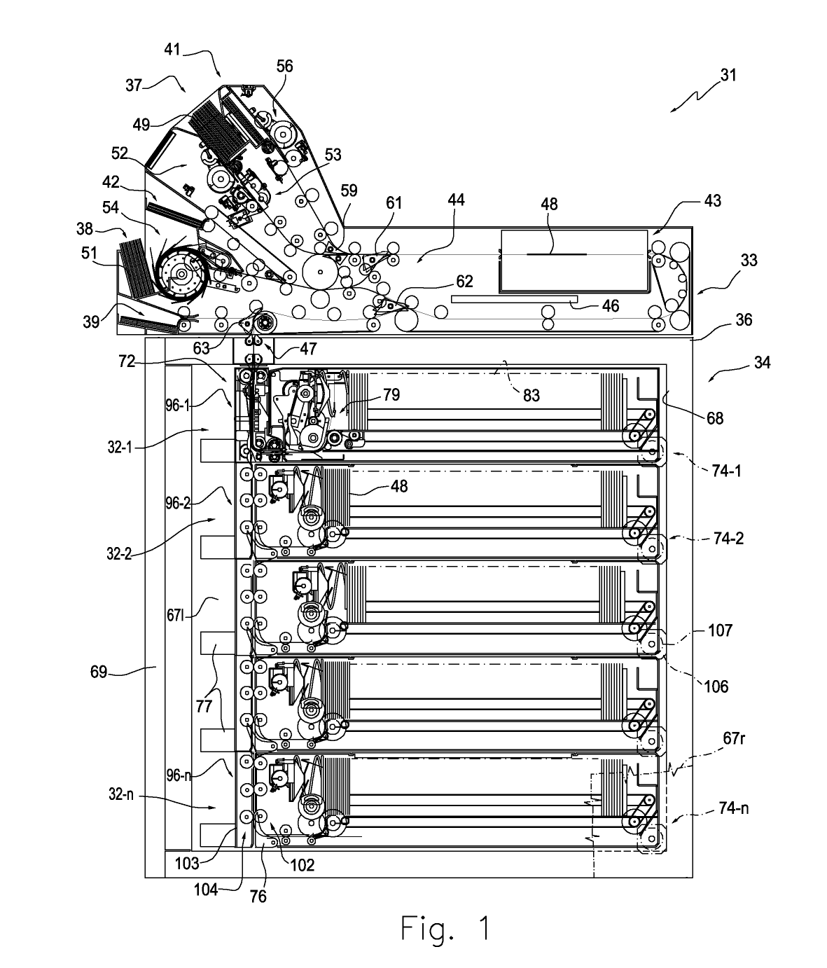

FIG. 1 shows, in a schematic form, an equipment 31 for the automatic deposit and withdrawal of banknotes, with a series of respective receipting or dispensing modules or boxes 32-1, 32-2, . . . 32-n.

The equipment 31 includes, overlapped, an upper body 33 and a lower body 34. The upper body 33 is of interface for the deposit and the delivery of the banknotes by the operator, while the lower body 34 is defined by a store-safe 36 in which the modules 32-1, 32-2, . . . 32-n. are lodged. The equipment 31 can process flexible documents different from the banknotes, as cheques and notes. From now forward the term banknotes, however, will also designate such flexible documents

The upper body 33 includes, in a conventionally frontal portion, an input port 37 for depositing and introducing the banknotes, an output port 38 for their dispensing, a forgery vane 39, a deposit rejection vane 41 and a withdrawal rejection vane 42. The ports 37 and 38 are open and accessible by the user, while the vanes 39, 41 and 42 are closed and accessible through keys. Moreover are in evidence, inside the body 33: a validation device 43 in a rear portion, an interface transport mechanism 44, an electronic control unit 46, and an input-output port 47 of connection with the store-safe 36. The above mentioned components of the upper body 33, can be of known type and are summary described in the following.

The input port 37 and the output port 38 are provided for receiving banknotes 48 introduced by the user in a deposit stack 49 and, respectively, for receiving banknotes required by the user by a withdrawal stack 51. The forgery vane 39 receives the banknotes suspect of forgery; the deposit rejection vane 41 is intended for receiving the components of the stack 49 rejected by the equipment 31 in the phase of deposit and not withdrawn by the user, while the withdrawal rejection vane 42 is in turn provided to receive the banknotes discarded by the equipment 31 in the phase of withdrawal.

As far as the deposit it concerns, an input separating device 52 and a preliminary control device 53 are arranged in sequence between the input port 37 and the transport mechanism 44. The separating device 52 provides the separation of the banknotes 48, while the control device 53 verifies the thickness of the separated component for what it relates to the presence of extraneous materials and the double separations.

As for the withdrawal, a stacking wheel 54 arranges in superimposition the banknotes 48 coming from the mechanism 44 and directed to the output port 38. Finally a receiption and separating device 56 provides to overlap and separate, for further processings, the banknotes 48 rejected by the deposit rejection vane 41.

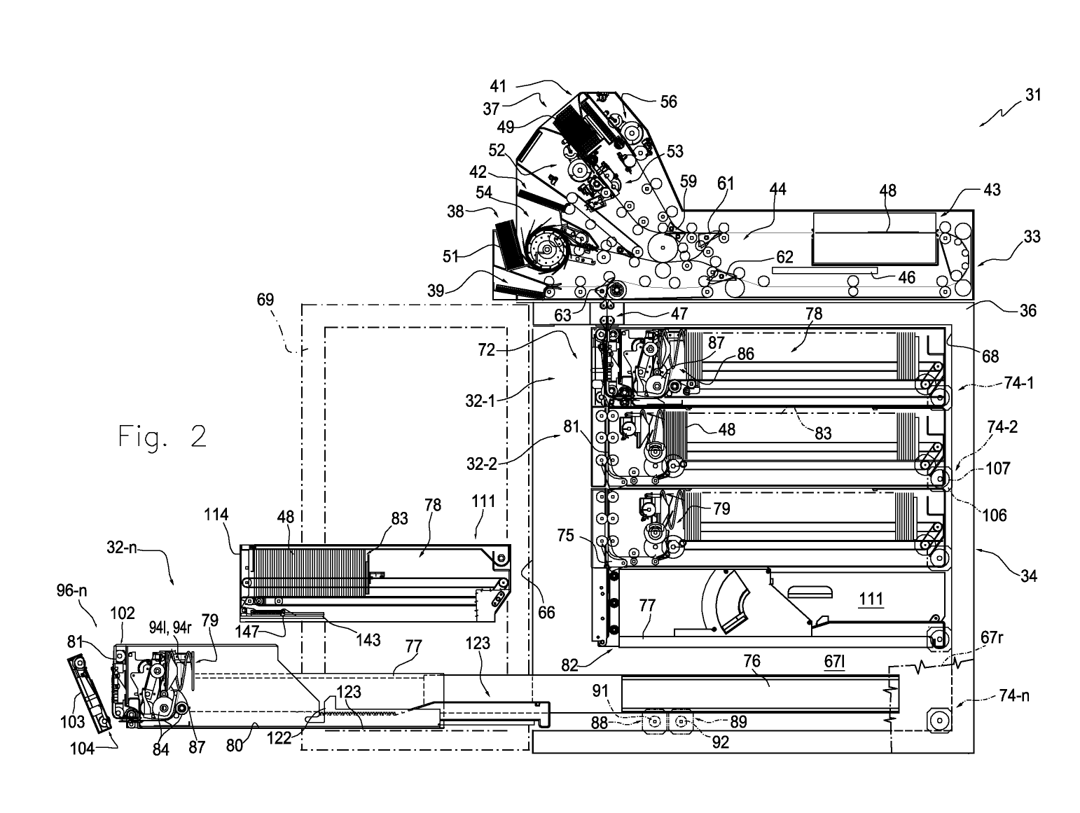

The interface transport mechanism 44 comprises a passive diverter 59 and controlled diverters 61, 62 and 63 for connecting the transaction ports and the banknote vanes with the validation device 43 and the input-output port 47 (FIGS. 1 and 2).

The store-safe 36 has a front opening 66, side walls 67l and 67r, a rear wall 68, a door 69 for the opening 66 and a plurality of housings for the receipting and dispensing modules 32-1, 32-2, . . . 32-n. In the store-safe 36 are mounted a store transport mechanism 72, a transport moving member 73 (FIG. 9) for the mechanism 72 and a plurality of stacking moving members 74-1, 74-2, . . . 74-n (FIG. 1) for the receipting and dispensing modules. The housings for the modules are arranged on a line, in vertical, and receive each one a respective module 32-1, 32-2, . . . 32-n for a corresponding arrangement in superimposition of the same modules.

The store transport mechanism 72 has a substantially vertical path and comprises diverting members 75 for each module 32. Through the diverting members 75, the mechanism 72 moves the banknotes 48 between the input-output port 47 and the modules 32. The door 69 is provided of a safety lock, not shown in the figures, and it makes to access to the transport mechanism 72 and the modules 32-1, 32-2, . . . 32-n. Couples of guides 76 (FIG. 2) are mounted in a telescopic way between the walls 67l and 67r of the store-safe 36 in the space provided for the housings for the modules. Through respective intermediate supports constituted by trays 77, the modules 32-1, 32-2, . . . 32-n are mounted between a respective couple of guides 76, with possibility of slide in horizontal between an operative position (modules 32-1 and 32-2) and a service position (module 32-n). The operative position is internal to the store-safe 36 and is functional to each module 32 for the reception and the dispensing of the banknotes 48. The service position is external to the store-safe 36 with arrangement of the modules 32 countlever through the opening 66, and functional to each module for operations on the banknotes 48 connected with the emptying and the recharging and for maintenance.

The receipting and dispensing modules 32-1, 32-2, . . . 32-n have dimensions and functionality similar to the dimensions and the functionality of the boxes for deposit and dispensing of banknotes described in the Italian Patent Application No. TO2006A00094 filed on Oct. 2, 2006 in the name of the applicant CTS Cashpro S.p.A. and whose content is herein included as reference.

The receipting and dispensing modules 32-1, 32-2, . . . 32-n are of substantially parallelepiped shape, lengthened in depth, and present a collecting seat 78 and an insertion and extraction device 79 for the banknotes 48. Each module 32 has in evidence a base structure 80, a front wall 81 and a bottom with an opening 82, of input-output for the banknotes adjacent to the wall 81. In the seat 78, the banknotes 48 are lodged with arrangement in vertical and support on longer side and define a stack represented with 83. The device 79 has the function of introducing in an orderly way and stacking the banknotes in the seat 78, in association with the deposit. The device 79 has also the function of singularly extracting the banknotes from the module 32, through unstacking-separation operation from the stack 83, in association with the withdrawal.

In each module 32, the insertion and extraction device 79 comprises introduction-extraction rollers 84 for the introduction and the extraction of the banknotes with respect to the recycling box, a separation member 86 for facilitating the introduction of the banknotes and a separating roller 87 for the unstacking operation of the banknotes from the stack 83. The introduction-extraction rollers 84 are arranged of few below the collecting seat 78 provided for the stack 83, while the separation member 86 is interposed between the input-output opening 82 and the stack of banknotes 83. The separation member 86 is shiftable between an operative position downstream of the separation roller 87 in the sense of the stacking, as indicated for the module 32-1 for a configuration of deposit of banknotes, and a non-operative position, upstream of the separation roller, as indicated for the module 32-2 relatively to a dispensing configuration.

For motorizing the single modules 32-1, 32-2, . . . 32-n, respective configuration motors 88 are functional to the separation member 86, while introduction-extraction motors 89 actuate the rotation of the introduction-extraction rollers 84. The motors 88 and 89 are mounted on the wall 67r of the store safe 36 and comprise respective driving gears 91 and 92 projecting from the wall 67r in correspondence of the modules housings. In the operative position of the modules 32, the driving gears 91 and 92 engage taking gears, not shown in the figures, for some functions regarding the separation member 86 and, respectively, for the rotations of the introduction-extraction rollers 84 and the separation roller 87 of the respective module 32. The introduction of the banknotes is associated to a given sense of motion of the motor 89, while the extraction is associated to an opposite sense of motion. The stack of banknotes 83 of each module is moved jointly with the operations of introduction and extraction of the banknotes by means of a pressing element actuated by the respective stacking moving member 74-1, 74-2, 74-n.

Similarly to what described in the cited Patent Application TO2006A00094, the separation member 86 for each module 32, between the input-output opening 82 and the stack of banknotes 83 comprises two spirals of insertion banknotes, herein represented with 94l and 94r, extended in the sense of the stacking, for overlapping the banknotes in deposit on a terminal surface of the stack 83. The spirals 94l and 94r are rotated by the driving gear 91 of the respective configuration motor 88, through the taking gear and a kinematic chain not shown in the figures. The spirals 94l and 94r are shifted between the operative position and the non-operative position on control of a cyclical actuation mechanism, also not shown in the figures, sensitive to the change of the sense of rotation of the introduction-extraction motor 89, and actuation by means of the moving stacking member of the pressing element of the stack 83.

In the operative position, the spirals 94l and 94r are in contact with the stacking surface of the stack of banknotes 83 and the insertion of the banknotes takes place from the bottom upwards by means of the introduction extraction rollers 84. The spirals 94l and 94r are rotated by the configuration motor 88 in synchronism with the movement of the entering banknotes so that the same banknotes are received between the spirals and move on the stacking surface. In the non-operative position of the spirals 94l and 94r, the stacking surface is in contact with the separation roller 87. The respective introduction-extraction motor 89 makes the roller 87 to rotate, for extracting the banknotes from the top downward from the stack of banknotes 83. Then the banknotes are shifted toward the diverting members 75 and the transport mechanism 72, by means of the introduction-extraction rollers 84.

The mounting of the modules 32 between the guides 76 provide, as an example, screw knobs 85 of the trays 77 coupable with seats of the base structure 80. With this structure and in the service positions, the modules have possibility of easy removal and replacing with respect to the equipment 32.

According to an aspect of the present invention, the store transport mechanism 72 has individual sections 96-1, 96-2, . . . 96-n, associated with the single modules 32-1, 32-2, . . . 32-n and mounted on the same modules, and in which the respective diverting members 75 are arranged adjacent to the opening 82. The individual sections 96-1, 96-2, . . . 96-n are moved therefore together with the modules 32-1, 32-2, . . . 32-n in the service position and have possibility of access to corresponding sections of the banknotes path between the modules 32 and the input-output port 47. The individual sections of the transport mechanism 72 (FIG. 9) take the motion, or directly by the transport moving member 73, or through another of the individual sections 96.

In an exemplary embodiment, the transport moving member 73 comprises a motor 97 and a motor pinion 98 mounted in the store safe 36. The pinion 98 is actuated by the motor 97 and projects from an upper section of the lateral wall 67l adjacent to the opening 66. The individual sections 96-1, 96-2, . . . 96-n of the mechanism 72 include each one a taking gear 99 adjacent to an upper portion of the module 32 and a transmission gear 101 adjacent to a lower portion and connected in the rotation with the taking gear 99 of the underlying individual section.

In the operative position, the individual section 96-1 associated to the module 32-1 takes the motion from the motor pinion 98 through the taking gear 99, as indicated in FIG. 9. The section 96-2 of the module 32-2 takes the motion from the transmission gear 101 of the section 96-1, through the taking gear 99. In turn it transmits the motion to the lower individual section, and so on to the section 96-n. In the service position of a module 32 and in the operative position of the other modules, the taking gear 99 is disengaged by the transmission gear 101 of the upper module or by the pinion 98, while the gear 101 is disengaged by the taking gear 99 of the lower module.

The individual sections 96-1, 96-2, . . . 96-n of the mechanism 72 include each one a series of transport rollers 102 (FIG. 8), a frame 103 and a series of counter-rollers 104. The transport rollers 102 are supported in the rotation by the frontal wall 81 and are connected with the taking gear 99. The frame 103 is fulcrumed in correspondence of the input-output opening 82 of the module 32 and supports in the rotation the series of the counter-rollers 104. The frame 103 is shiftable between an operative position of transport and an access position. The transport position is adjacent to the wall 81 for an arrangement of the counter-rollers 104 in contrast with the transport rollers 102, while the access position is far away by the wall 81 for an arrangement of the counter-rollers 104 spaced away by the rollers 102. Elements of locking, not shown in the figures, maintain the frame 103 in the transport position and are manually actuable for the positioning of the frame in the position of access.

In the transport position of the frame 103 and for the operative position of the module 32 (FIG. 1), the transport rollers 102 and the counter-rollers 104 define fractions of path and transport of the banknotes in front of the modules 32-1, 32-2, 32-n, together with corresponding guide elements of known type. In these conditions, a banknote 48 in movement along this fraction of the section 96-1, 96-2, . . . 96-n can proceed toward the lower or upper module 32 or can be deviated toward the seat 78. Likewise, a banknote 48 emerging from the module 32 is deviable by the member 75 toward the rollers 102 and the counter-rollers 104 along the fraction of the section 96-1, 96-2, . . . 96-n and toward the input-output port 47. In the service position of the respective module 32 (FIG. 2), the locking elements can be released by means not shown, for spacing away the frame 103 by the wall 81 so as to allow the removal of banknotes 48 possibly clogged in the section 96-1, 96-2, . . . 96-n, in condition of liberty of movement of the transport rollers and without risks of tears.

The stacking moving members 74-1, 74-2, . . . , 74-n comprise each one a motor 106 and a transversal shaft with a respective motor pinion 107. The pinion 107 projects toward the inside from the rear wall 68 of the store safe 36. In the operative position of the module 32, the pinion 107 cooperates with a taking gear of the same module 32 to the end of shifting the stack of banknotes 83 along the collecting seat, as it will be later described.

According to the invention, at least one of the modules or boxes 32-1, 32-2, . . . , 32-n (for instance the module 32-n of FIG. 2) is a separable module and comprises a recycling container or cartridge 111, in which is defined the collecting seat 78 for the banknotes 48. The cartridge 111 (FIGS. 2, 3 and 4) is mountable and removable with respect to the base structure 80 and coupable with the insertion and extraction device 79. When the separable module is assembled with the recycling cartridge, the insertion and extraction device 79 is engageable with the stack of banknotes 83. Thus, in the operative position of the module and interfacing with the store transport mechanism 72, the insertion and extraction device provides to introduce the banknotes 48 into the cartridge 111 and, in alternative, to singularly extract the banknotes from the cartridge.

The assembling and the separation between recycling cartridge 111 and device 79 are manually effected in the service position of the respective receipting and dispensing module 32 and, specifically, for shiftings in horizontal and in vertical.

The cartridge 111 has substantially parallelepiped shape lengthened in depth and safety anti effraction features. The cartridge presents: a front opening which defines an area of access 113 for the terminal surface of the stack 83, an element of opening-closing for the area of access 113 defined by a plate 114, and an access command mechanism 116 for the plate 114. The area of access 113 is arranged in a terminal section, substantially rectangular, of the cartridge 111. When the cartridge is assembled with the module 32, the plate 114 is open and makes to access to the stack 83; at container separated by the module, the plate 114 normally closes the area of access 113.

Suitable, the separable module 32 comprises an actuating device 118 for the access command mechanism 116. The device 118 is pre-set to operate on the command mechanism 116, so as to open the plate 114 in association with the assembling of the container with the module and to close the plate 114 in association with the separation. Moreover, the module 32 defines a screen 121 in which the components of the insertion and extraction device 79 are lodged.

The screen 121 includes lateral walls 119r and 119l and a roof and is delimited in the front portion by the front wall 81 of the module 32. The screen 121 has a section complementary to the terminal section of the cartridge for receiving this terminal section in association with the assembly of the cartridge with the module 32. It mainly for preventing tampering in the area provided for the engagement between the stack of banknotes 83 and the insertion and extraction device 79.

The actuating device 118 of the module 32 comprises two “L” shaped notches 122, a movable frame 123 and a manual shifting member. The notches 122 are obtained internally on a lower portion of the lateral walls 119l and 119r of the screen 121, while the frame 123 is supported in a slidable way by the base structure 80. The frame 123 has a “U” shaped structure with two arms 124 and a rear crossbar and defines two notches 125 in an upper portion of the arms 124, adjacent to the rear crossbar. The manual shifting member works on the frame 123 for facilitating the assembling of the cartridge with the module 32.

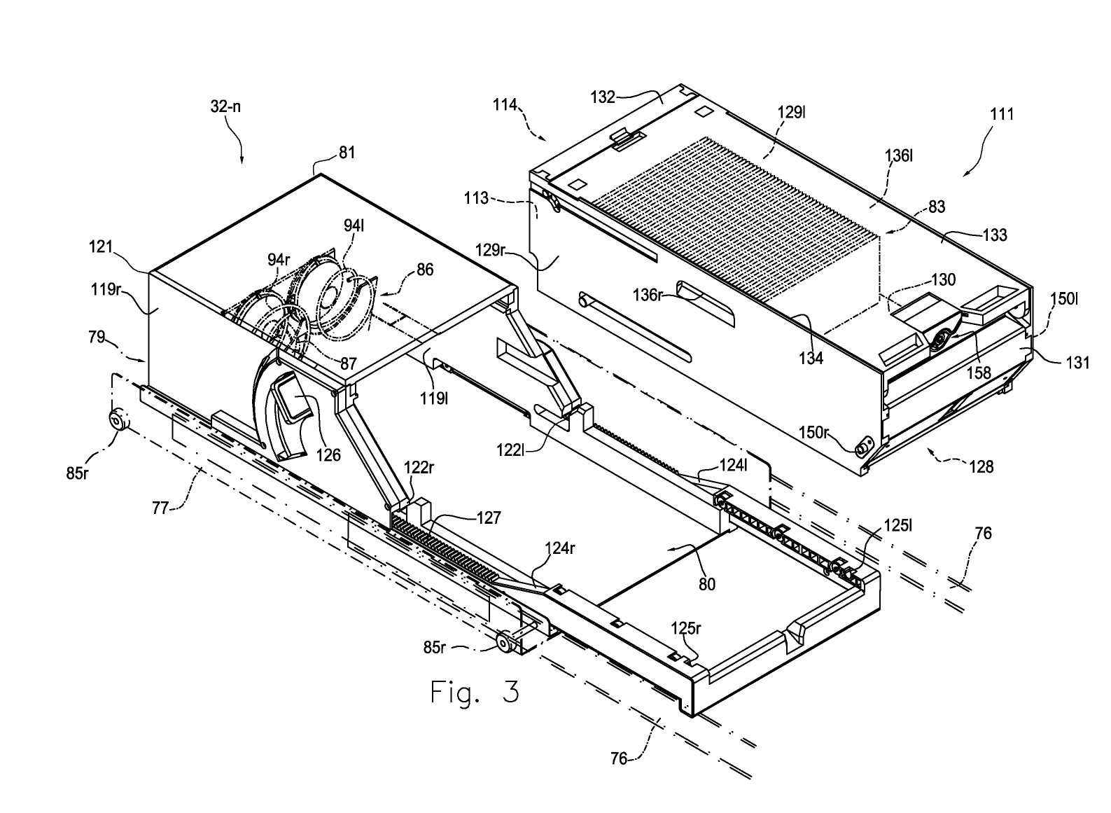

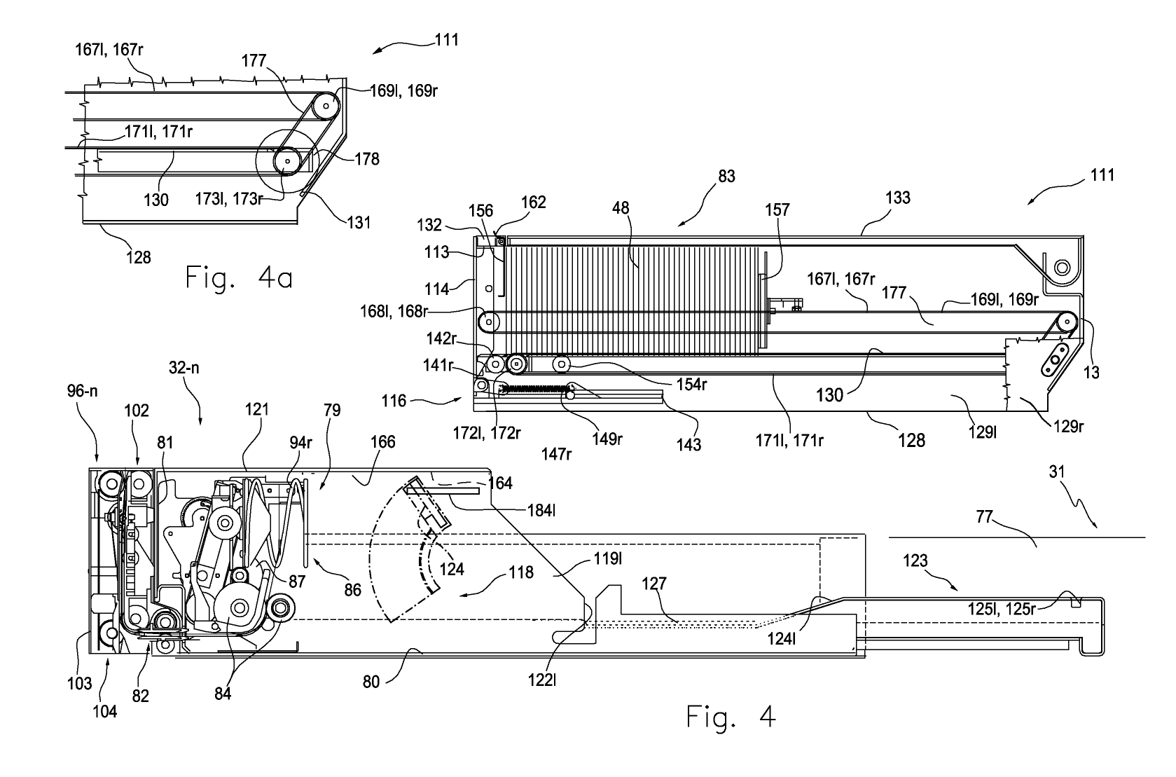

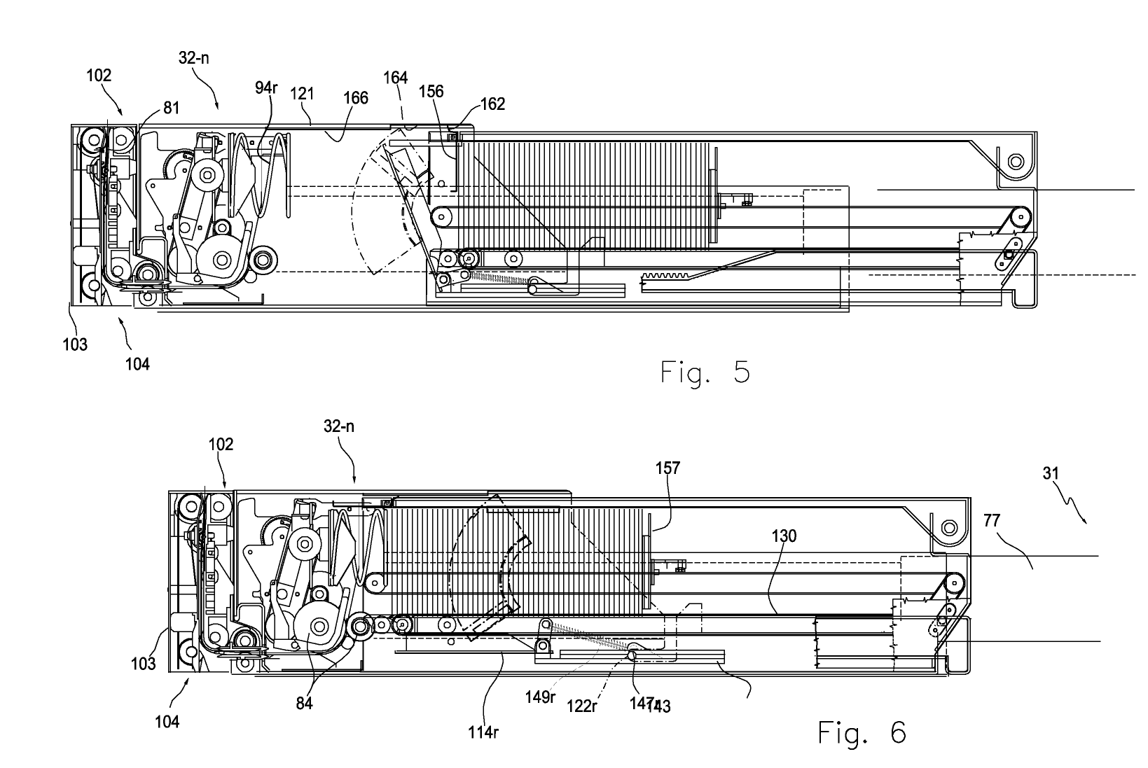

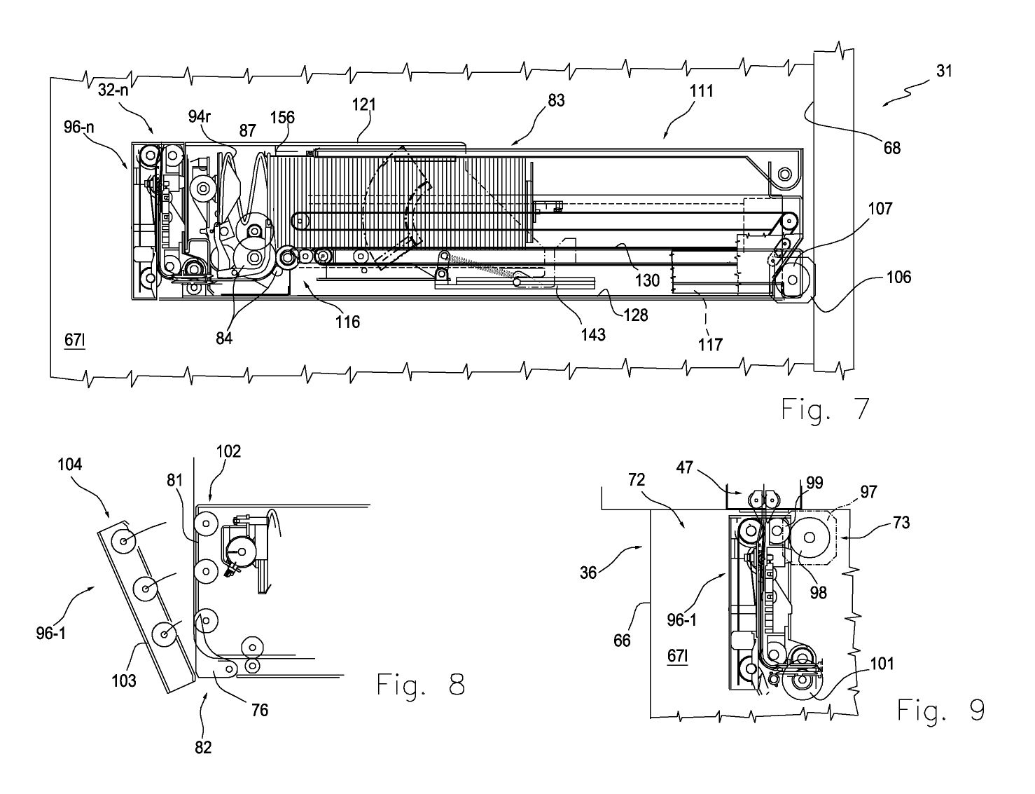

Specifically, the manual shifting member comprises a lever knob 126 fulcrumed on the wall 119r and connected, through a chain of gears and a pinion, not shown in the figures, with a rack 127 obtained on one of the arms 124 of the frame 123. The knob 126 is shiftable between an upper position, of assembling and a lower position, of non-operativity for the module 32. In the upper position (FIGS. 3 and 4), the knob 126 determines an extracted condition of the frame 123 shifted toward the rear portion of the base structure 80. In the lower position (FIGS. 6 and 7), the knob 126 determines a closed condition of the frame 123 in which the crossbar is in contact with the rear portion of the structure 80.

The cartridge 111 (FIGS. 3 and 4) includes a bottom 128, two lateral walls 129l and 129r, a base 130, a rear wall 131, an upper crossbar 132 in correspondence of the area of access 113 and a cover 133. The base 130 is arranged above the bottom 128 and is of partial support for the stack of banknotes 83. The cover 133 is associated to an upper opening 134, above the stack 83, for manual operations of empting and recharging of the cartridge. Moreover, two recesses 136 at the outside of the walls 129l and 129r facilitate the manual taking of the cartridge 111, in the transport and in the assembling or removal phases regarding the module 32.

The cover 133 is fulcrumed in correspondence of the rear wall 131 of the cartridge 111, with contrast of a front edge on the crossbar 132 and is lockable by means of a lock for closing with safety the opening 134, as it will be described in the following. The area of access 113 to the stack of banknotes 83 extends with the whole front section of the cartridge between the walls 129l and 129r, the base 130 and the crossbar 132.

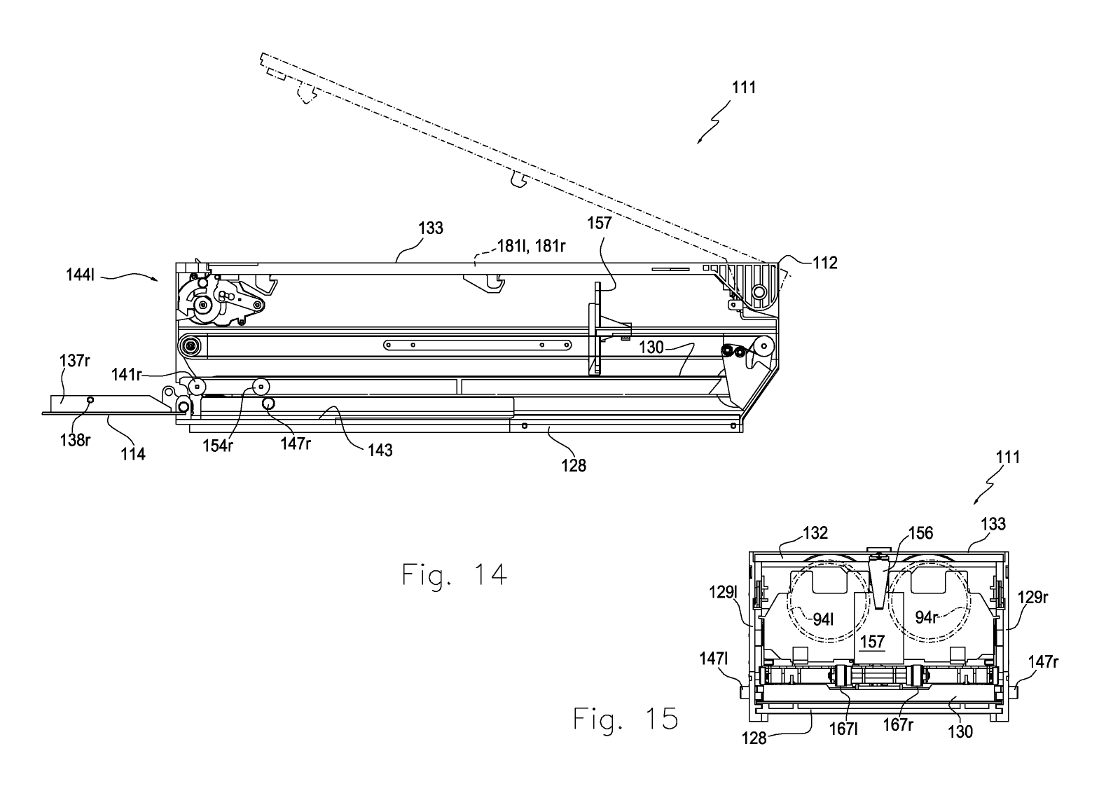

The plate 114 (FIGS. 4, 7 and 14) is of balance type, with fulcrum and shifting close to a lower edge and is lodgeable, when it is open, in an interspace of the cartridge 111 between the base 130 and the bottom 128. In detail, the plate 114 comprises two lateral ribs 137 adjacent to lateral contrast edges, two locking pins 138, projecting from the ribs 137 and two projections adjacent to a lower contrast edge. The ribs 137 define respective cam profiles 141, having each one a terminal section sloping down toward the lower contrast edge. The profiles 141 are provided for cooperating with respective cam follower rollers 142 mounted on the lateral walls 129l and 129r of the cartridge 111.

The access command mechanism 116 includes a slide member 143 and two door locking groups 144. The slide member 143 is mounted slidably in the interspace between the base 130 and the bottom 128 of the cartridge 111 and includes in a front part two lugs with respective pivots 146, of fulcrum for the plate 114, through the projections adjacent to the lower contrast edge. Laterally, the slide member 143 has two slide control pins 147 projecting from the walls 129l and 129r through two slots 148 parallel to the bottom 128. Two return springs 149 arranged at the sides, between the plate 114 and the slide member 143, urge the plate 114 toward the closing position. Two contrast pins 150 are further provided of coupling for the cartridge 111, fixed closed to the lower edges of the walls 129l and 129r, adjacent to the rear wall 131.

The door locking groups 144 comprise respective shaped hooks 151, provided for cooperating with the locking pins 138 in the condition of closing of the plate 114. The hooks 151 have discoid shape, fulcrumed on respective pivots of the walls 129l and 129r and are provided for being positioned between a position of engagement with the door locking pins 138 and a position of disengagement from the pins 138.

In condition of rest and liberty for the plate 114, the springs 149 determine a position of equilibrium in which the slide member 143 is in an advanced position, while the terminal sections of the cam profiles 141 are engaged by the cam follower rollers 1421 and the plate 114 is closed. In the position of disengagement of the hooks 151, the shifting in a forced way the slide member 143 toward the rear portion with respect to the cartridge 111 causes a rotation of the plate 114 in the sense of the opening, with fulcrum of the profiles 141 on the couple of the cam follower rollers 142 and against the action of the springs 149.

Proceeding with the shifting between plate 114 and cartridge 111, the ribs 137 present to the cam follower rollers 142 a rectilinear portion of the cam profiles 141, such to dispose the plate parallel to the bottom and in condition of maximum extension of the springs 149. A further shifting of the slide member 143 toward the rear portion of the box determines the complete positioning of the plate 114 in the interspace between the bottom 128 and the base, with the rectilinear portion of the cam profiles 141 engaged by a second couple of cam follower rollers 154, mounted on the walls 129l and 129r.

In the device 118, the “L” shaped notches 122 are pre-set for receiving the slide control pins 147, while the recesses 125 are arranged for receiving the contrast pins 150, jointly with the setting of the cartridge 111 in the base structure 80. In a pre-assembly phase, with knob 126 in upper position and frame 123 extracted, the cartridge 111 can be positioned above the base structure 80 and then lowerered, so as to cause the control pins 147 to be engaged in the notches 122 and the contrast pins 50 to be lodged in the recesses 125.

A rotation of the knob 124 in a counterclockwise sense in FIG. 4, through the relative chain of gears and the rack 127, causes the movable frame 123 to advance toward the front position and the cartridge 111 to be shifted with the stack of banknotes 83 to the inside of the screen 121, while the slide member 143 is still, bound to the base structure 80. The reciprocal movement between the slide member 143 and the cartridge 111 causes the opening of the plate 114 and the progressive insertion of the plate underneath the base 130, in the above described way, without interference with the spirals of insertion 94l and 94r of the insertion and extraction device 79.

At the end of rotation of the knob 124, low position of FIG. 7, the assembling of the cartridge 111 with the module 32 is completed. The terminal surface of the stack 83 is in contact with the spirals 94l and 94r of the insertion and extraction device 79 and the introduction extraction rollers 84 are in operative condition for the introduction of the banknotes with respect to the base 130, as described in the above cited Patent Application TO2006A00094.

According to the present invention, the recycling cartridge 111 comprises a keeping element 156 in an upper portion of the area of access 113, and a pressing element 157 with functions of front and back contrast for the banknotes of the stack 83. When the cartridge is assembled with the module 32, the insertion and extraction device 79 replaces the keeping element 156, holding back the banknotes 48 against the action of the pressing element 157 in the operations of insertion and in the unstacking operations.

Suitably, the recycling cartridge 111 comprises a key mechanism 158 for the plate 114. The plate 114 is locked on the cartridge 111 when the same cartridge is separated by the module 32 and in condition of cartridge removed. After unlocking of the key mechanism 158, the plate 114 can be opened for the action of the actuating device 118 at the moment of the installation in the module. The key mechanism 158 also operates for the locking of the cover 133.

In detail, the keeping element 156 comprises an arm 159 fulcrumed in central position on the upper crossbar 132 and opposed by a spring 161. The arm 159 has a lug 162 projecting upward through a notch 163 of the crossbar 132. In turn, the screen 121 defines, in the roof, a notch 164 for the lug 162 and a projection 166, toward the inside, at the end of the notch 163. When the cartridge is removed, the arm 159 is kept in vertical position for the stopping of the lug 162 against the bottom of the notch 163, with function of keeping for the stack of banknotes 83.

At the moment of the insertion of the cartridge 111 into the screen 121, the lug 162, after sliding along the notch 164, is shifted by the projection 166 of the screen against the action of the spring 161. Therefore, the arm 159 is carried in a horizontal position above the stacks of banknotes, jointly with the opening of the plate 114 and according to a trajectory without interference between the spirals 94l and 94r. The insertion of the cartridge 111 can freely proceed up to the contact of the terminal surface of the stack of banknotes against the ends of the spirals 94l and 94r.

In the cartridge 111, the pressing element 157 is formed by a vertical plate moved by the upper branches of two lengthened toothed belts 167, which extend through the space provided for the stack of banknotes 83. The belts 167 are engaged between two couples of pulleys 168 and 169 mounted adjacent to the area of access 113 and at the rear wall 131 in respective seats of the lateral walls 129l and 129r. Two other toothed belts 171, also of lengthened shape and extended through the space provided for the stack of banknotes, are engaged between two respective couples of pulleys 172 and 173 mounted adjacent to the area of access 113 and to the wall 131, underneath the base 130. The upper branches of the belts 171 project of few from the base 130 and support the lower edges of the banknotes of the stack 83. The pulleys 169 are keyed on an upper axis 174, while the pulleys 172 are keyed on a shaft 175 arranged below the base 130.

The shafts 174 and 175 are connected in the rotation through respective toothed pulleys and a transmission belt 176, for a condition of synchronism between the belts 167 and the belts 171. On the shaft 175 is keyed a taking gear 178. When the cartridge 111 is mounted, and in the operative position of the module 32, the gear 178 is engageable with the motor pinion 107 projecting from the rear wall 68 of the respective housing of the equipment 31. Thus, in dependence of the sense of rotation of the motor 106 of the moving member 74, the pressing element 157 and the upper branches of the belts 171 can be moved frontwards or backwards with respect to the base 130, for a contemporary frontward or backward movement of the stack of banknotes 83, in a way similar to what is described in the cited Patent Application TO2006A00094.

Lastly, the cartridge 111 includes a braking mechanism for the pressing element 157, not shown in the figures, operative on the taking gear 178, when the module 32 is out of the operative position. For instance, this braking mechanism includes an arrest tooth controlled, through leverages, by a contrast member adjacent to the wall 68 of the store safe 36. It ensures that the stack of banknotes remains locked against the keeping element 156.

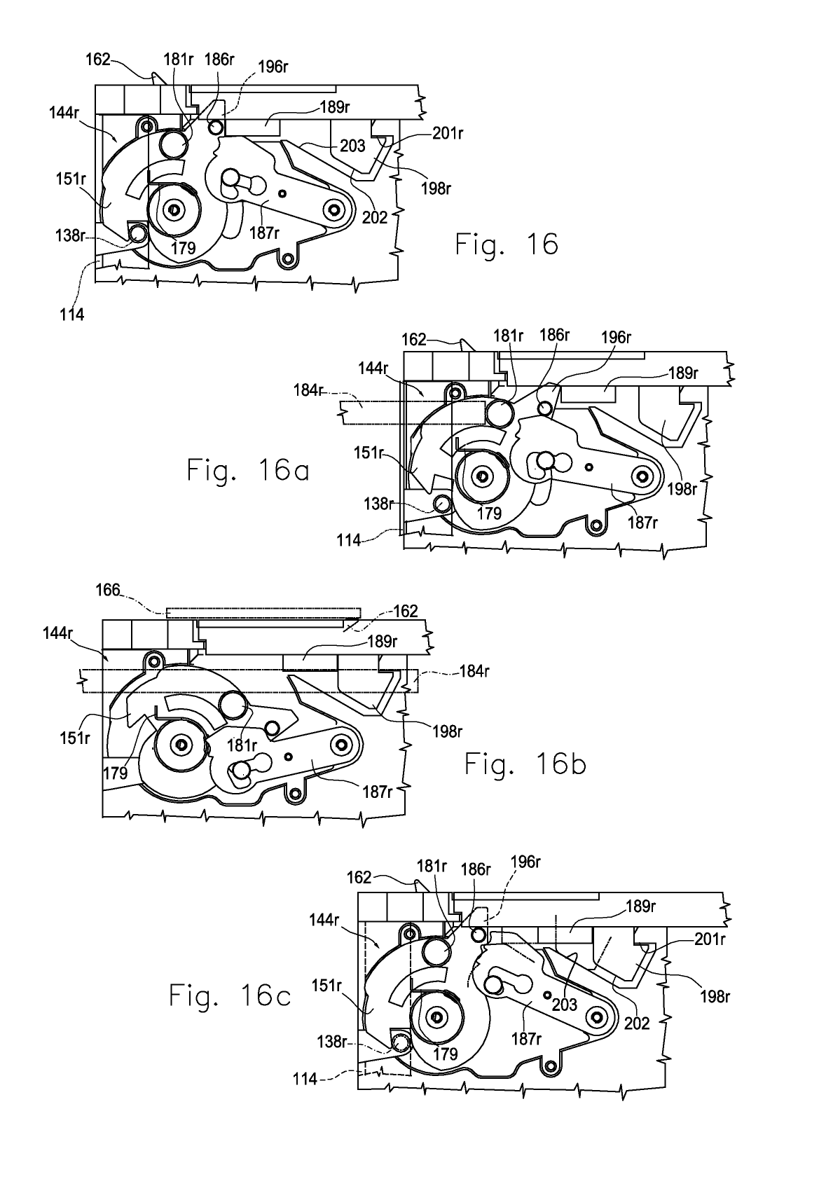

In the access command mechanism 116 (FIGS. 12 and 16), the shaped hooks 151 are urged by springs 179 toward the position of engagement for the door locking pins 138. On the hooks 151 are mounted two respective hook control pins 181 projecting toward the outside from respective arc shaped slot 182 obtained in the walls 129l and 129r of the cartridge. The pins 181 are arrested by upper stroke ends of the slots 182, in the positions of engagement of the hooks 151. Further, the walls 129l and 129r define two rectilinear grooves 183 having axes parallel to the bottom 128, tangent to the upper stroke ends of the slots 182. There are also provided hook arrest pins 186 projecting toward the inside from the hooks 151 and two arrest levers 187 fulcrumed close to he hooks 151. The levers 187 are urged in a counterclockwise sense by springs not shown and are provided to oppose, with function of locking, the hook arrest pins 186.

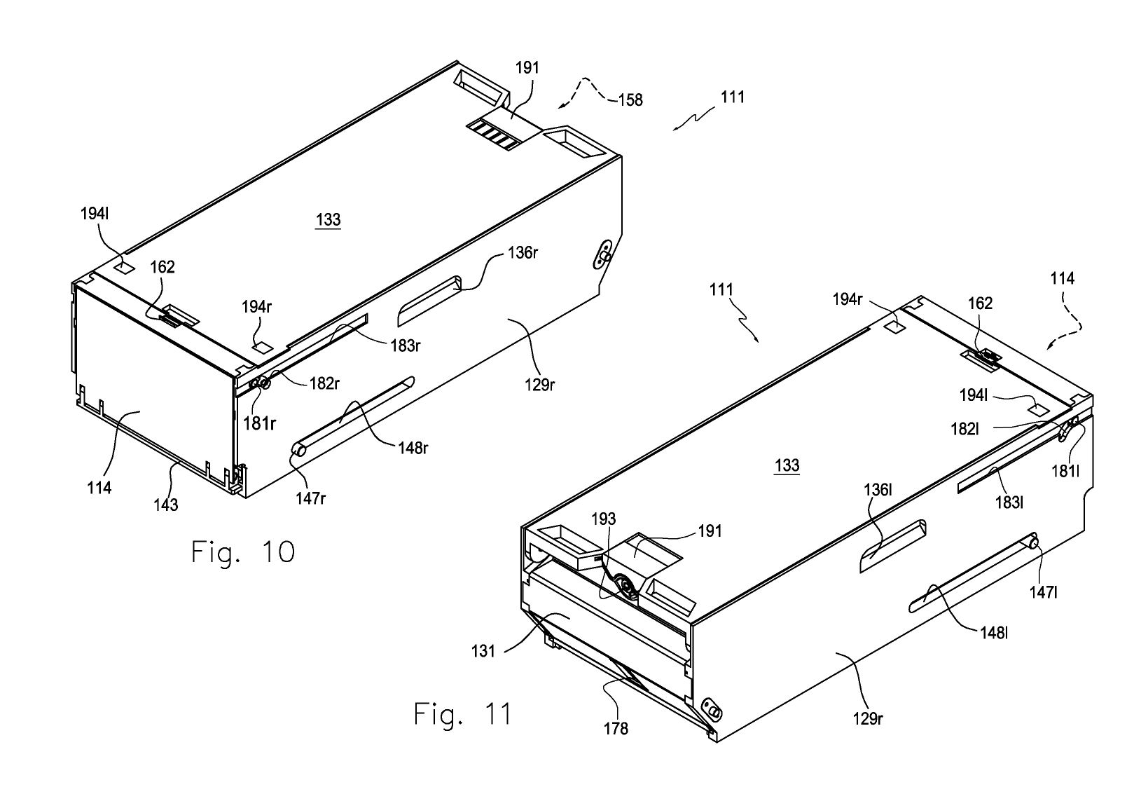

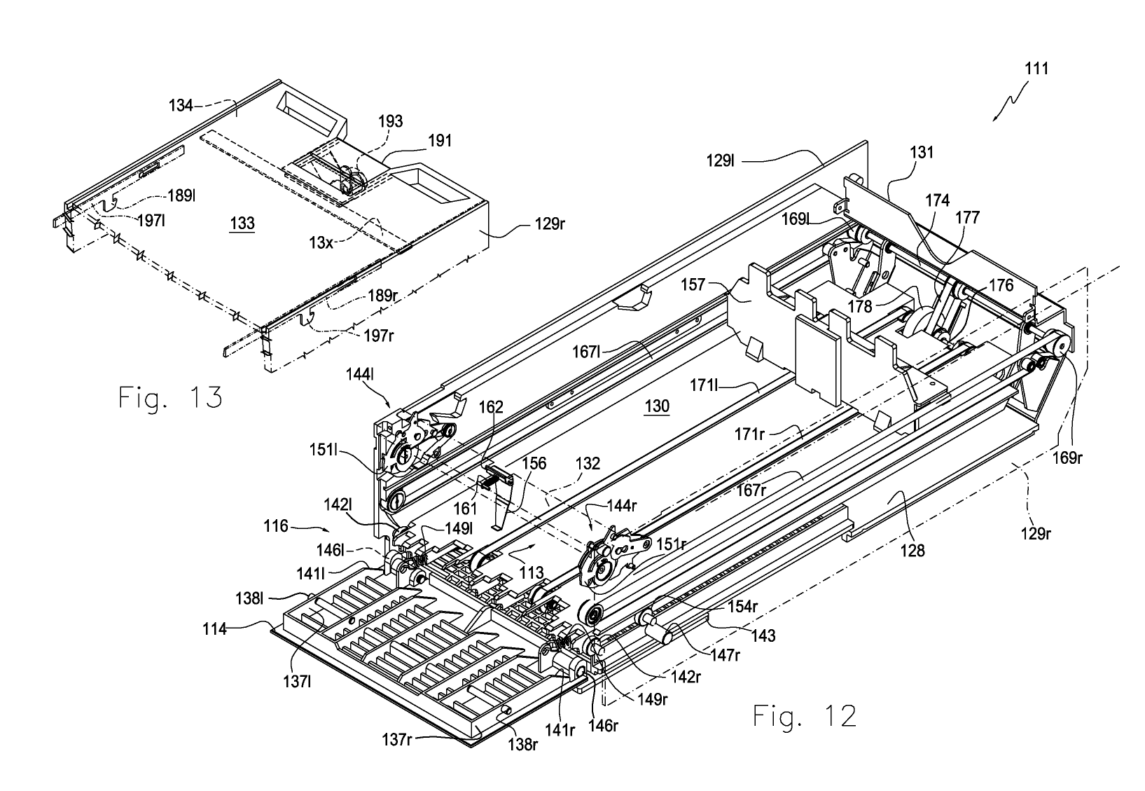

In turn, the actuation device 118 of the module 32 comprises, inside the screen 121, two projections 184 (only one visible in FIG. 3) which are provided to be slidably lodged in the grooves 183 (FIGS. 9, 10, 11 and 15) of the cartridge 111 and cooperate with the control pins 181. With the mounting of cartridge in the base structure 80 and following the rotation of the knob 124, the projections 184 can move the hook control pins 181 with respect to the cartridge 111, making the hooks 151 to rotate clockwise, unless of actions of locking on the same hooks.

The key mechanism 158 for the plate 114 comprises: two sliders 189, an actuation handle 191 with a crossbar 192 mounted on the cover 133 and a lock 193 mounted on the rear wall 131 of the cartridge 111. The sliders 189 are slidable supported in depth internally to the sides of the cover 133, and are pulled backwards by return springs not shown in the drawings. The handle 191 is arranged slidably in a median rear portion of the cover 133 and is also pushed towards the rear portion by a spring, also not shown. The actuation handle 191 is manually shiftable toward the front portion for shifting the crossbar 192 by means of the sliders 189. The lock 193 is designed for stopping the handle 191 in its rest position with crossbar 192 spaced away from the sliders 189.

The key mechanism 158 also comprises two signalling blocks 194 mounted on the cover 133 in front of the sliders 189 and lugs 196 projecting upwards from the hooks 151. The blocks 194 have possibility of sliding in depth between two positions stabilized by springs (not shown in the figures) and are shiftable toward the front portion by the sliders 189. In the closed position of the cover 133, the blocks 194 are behind the lugs 196 and are provided for cooperating with the arrest levers 187.

The signalling blocks 194 have an upper surface with areas coloured in red and in green, individually visible trough windows of the cover 133. An advanced position of the blocks 194 (FIG. 16) regarding the visualization of the green area, is associated to a configuration of assembling of the cartridge with the module 32. In fact, in the advanced position of the blocks 194 and of rest of the sliders 189, the arrest levers 187 are arrested by the same blocks 194 and the hooks 151 are free of shifting toward the position of disengagement from the pins 138, in view of the absence of obstacle by the levers 187 on the pins 186.

A retracted position of the blocks 194 (FIG. 16c), corresponding to the visualization of the red area, is associated to a configuration of inaccessibility inside the box and further prevents the assembling of the cartridge 111 with the module 32. In detail, in the retracted position of the blocks 194, of rest of the sliders 189 and of engagement of the hooks 151, the arrest levers 187 are in a lifted position, behind the arrest pins 186 and prevent any shifting of the hooks 151.

Suitably, the key mechanism 158 also provides to lock the cover 133 jointly to the locking of the plate 114. The sliders 189 have teeth 197 and 198 for cooperating with respective shoulders 199 and 201 of the lateral walls 129l and 129r, adjacent to the upper edges, when the actuation handle 192 is in position of rest and the cover 133 is closed. In front, the teeth 197 and 198 have also inclined profiles 202 for cooperating with respective inclined profiles 203 of the lateral walls 129l and 129r to make easier the unhooking of the teeth 197 and 198 from the shoulders 199 and 201 with preliminary opening of the same cover, in a way known per sé.

The passage from the configuration of accessibility to the configuration of inaccessibility is automatic, in association with the removal of the cartridge 111 by the separable module 32 following its assembling. In fact, with reference to FIG. 16a, by returning to the condition of pre-assembling of the cartridge 111 in the base structure 80 of the module 32, the shifting of the cartridge inside the screen 121 makes the hooks 151 to rotate in a counterclockwise sense in the position of disengagement, as effect of the action of the projections 184 on the hooks control pins 181; in turn, the lugs 196 shift the blocks 194 into the rear position while the relative springs rotate clockwise the arrest levers 187, jointly with the opening of the plate 114, as represented in FIG. 16b. From this condition, a shifting of the cartridge inside the screen 121, as function of the removal, causes the plate 114 to be closed and allows the hooks 151 to return into the position of engagement with the door locking pins 138. The levers 187 are now shifted in a lifted position behind the arrest pins 186 and arrest stop the hooks 151, as represented in FIG. 16c. The complete removal of the cartridge by the module 32 does not modify the position of the various components, the cartridge is in the configuration of inaccessibility and the plate 114 is closed and locked.

The passage from the configuration of inaccessibility to the configuration of accessibility is possible when the cartridge 111 is removed by the separable module 32 and previous key unlocking of the actuation handle 191, through the lock 193. The following actuation of the handle 191 shifts the sliders 189 toward the front portion, with consequent shifting of the blocks 194 toward the advanced position, as dots and dashes represented in FIG. 16c. Consequently, the arrest levers 187 are rotated clockwise out of the trajectory of the arrest pins 186 and cause arresting against the same blocks 194, with releasing of the hooks 151 (FIG. 16). Moreover, the teeth 197 and 198 are disengaged from the shoulders 199 and 201 while the cover sets in the condition of pre-opening and can be opened. For controls, also the plate 114 can be opened by manually releasing the hooks 151 through the arrest pins 181.

After the operations of emptying or recharging of the banknotes or other operations of control on the cartridge 111 and extraction of the key, the cover 133 can be snap closed. It does not modify the position of the various components, the cartridge is in the configuration of assembling with the module 32, while the plate 114, closed but unlocked, will be opened by the actuation device 118 at the moment of the assembly with the module 32.

Naturally, the principle of the invention remaining the same, the embodiments and the details of construction of the equipments for the automatic deposit and withdrawal of banknotes and respective modules of receipting and dispensing can broadly be varied with respect to what has been described and illustrated, by way of non limitative example, without departing from the ambit of the invention.

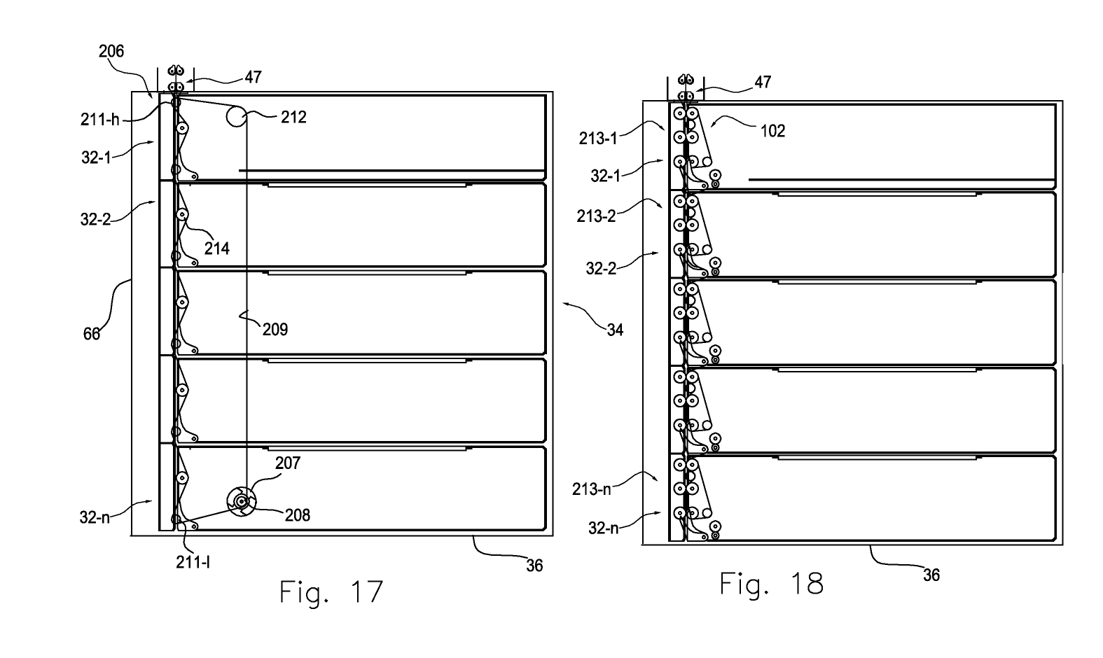

As an example, in FIG. 17 is shown a variant of the transport mechanism in store, represented with 206, comprising a transport motor mechanism 207 with a motor pinion 208, a belt 209, toothed on opposite faces, a couple of store transport rollers 211h and 211l and a contrast pulley 212. The belt 209 has lengthened configuration, extended in vertical through the whole height of the store safe 36; the rollers 211h and 211l are arranged adjacent to the opening 66, in the upper portion and respectively, in the lower portion of the store safe 36, while the pinion 208 and the pulley 212 are arranged behind the rollers 211h and 211l. A first branch of the belt 209 extends between the transport rollers 211h and 211l, while a second branch extends between the pinion 208 and the contrast pulley 212.

The modules 32-1, 32-2, . . . 32-n define respective individual sections 213-1, 213-2, . . . 213-n, similar to the sections 96-1, 96-2, . . . 96-n, which show each one a toothed pulley 214 integral in the rotation with the transport rollers of modules 102, and engageable with the teeth of the belt 209, while the contrast pulley 212 maintains in tension the belt 209. The toothed pulleys 214 of the modules 32 are pressure engageable with the first branch of the belt 209.

When the modules 32 are in the respective operative positions, all the transport rollers of modules 102 are provided for dragging the banknotes 48 along the individual sections 213-1, 213-2, . . . 213-n, without solution of continuity. Vice versa, when a module 32 is in the service position, the respective toothed pulley 214 is disengaged from the teeth of the belt 209 and maintain free the transport modules rollers 102.

The equipment for the deposit and the automatic withdrawal of banknotes can use receipting and dispensing modules with members of separation of the insertion and extraction device different from the spirals of insertion banknotes of the cited Italian Patent Application TO2006A00094. As an example such member can be formed by controlled guiding plates and flexible wheels arms, of known type.

Also the various components of the recycling box, as the opening-closing element and the respective control and locking mechanisms can be different from the ones above described. For instance, instead of a balanced plate, the recycling box can provide a series of articulated laminar elements, of known type.

The modules 32-1, 32-2, . . . 32-n are mounted in the respective guides 76 by means of known type, not represented, and can be removed by the guides and replaced with other modules for maintenance operations in alternative without departing from the ambit of the invention, manual mounting means can be provided, such to allow facilitated disassembling and mounting of the same modules to proceed with the assembling of the respective recycling cartridges, when the module 32 is removed from the equipment 32.

1. Equipment for the automatic deposit and withdrawal of banknotes comprising a store safe and a series of banknote receipting and dispensing modules or boxes, and in which each module includes a collecting seat and an insertion and extraction device for the banknotes, said equipment being characterized in that the receipting and dispensing modules or boxes are mounted with individual possibility of shifting in the store safe between an internal operative position and an external service position; at least one of the receipting and dispensing modules is a removable module and includes a container or recycling cartridge; and in which the recycling container is removable and is assemblable with respect to the insertion and extraction device in the position of service of the removable module, said recycling container defining the collecting seat for lodging a stack, with arrangement of the banknotes substantially in vertical.

2. Equipment according to claim 1 in which the receipting or dispensing modules or boxes are arranged in relationship of superimposition, said equipment being characterized in that it comprises guiding members for guiding each module in horizontal between the operative position and the service position, and in which the service position is countlever with respect to the store safe.

3. Equipment according to claim 2 comprising a store transport mechanism with substantially vertical path, and in which the store safe has an opening with a door in a conventionally frontal section, the equipment being characterized in that the guiding members guide each module through said opening and in which the transport mechanism has frontal extension in front of said modules and has individual sections mounted on an anterior section of the said modules.

4. Equipment according to claim 2 characterized in that each removable module includes a base structure for the mounting of the container, the equipment comprising, for each removable module, an intermediate support for the base structure mounted on the guiding members, and in which each module is mounted in a removable way with respect to the intermediate support.

5. Equipment according to claim 1 characterized in that the insertion and extraction device of each removable module is engageable with the stack of banknotes in the condition of assembled container for entering the banknotes in the recycling container and, in alternative, for extracting the banknotes from the said container.

6. Removable module according to claim 1 characterized in that the respective recycling container has a conventionally frontal opening for the access of the insertion and extraction device to a terminal surface of the stack of banknotes, and in which said container is mountable and detachable through horizontal and vertical shiftings.

7. Equipment according to claim 6, characterized in that each removable module includes a screen of protection for the insertion and extraction device and-or receiving a terminal section of the container, and in which the shifting in horizontal are associated to the insertion and the disinsertion of the section terminal with respect to said screen.

8. Equipment according to claim 1, characterized in that it comprises individual transport sections for moving the banknotes from the receipting and dispensing modules and toward said modules, the individual sections being integrally mounted on the single receipting and dispensing modules and being shiftable together with the respective modules, and with possibility of individual opening and closing.

9. Equipment according to claim 1, in which the banknotes of the stack have support on a longer edge, characterized in that the recycling container includes an area of access to the terminal surface of the stack of banknotes in a conventionally anterior section and a keeping element adjacent to the area of access for keeping back the banknotes of the stack, and in which said removable module includes command elements, operative on the keeping element for disengaging the keeping element from the stack, jointly with the assembling of the container with a structure of base.

10. Equipment according to claim 1, characterized in that the introduction and extraction device includes introduction-extraction rollers for the introduction and the extraction of the banknotes with respect to the recycling container, a separation member for facilitating the introduction of the banknotes and a separation roller for the unstacking operation of the banknotes from the stack, in which the separation member is shiftable between an operative position, downstream of the separation roller in the sense of the stacking and an unoperative position, upstream of the separation roller and in which, in the condition of container assembled with the module and in the dispensing configuration, the separation roller engages the terminal surface of the stack for the separation and the extraction of the banknotes while, in the deposit configuration, the separation member defines a space of insertion for the banknotes, upstream of said terminal surface for the introduction of the banknotes.

11. Equipment according to claim 1, characterized in that it comprises a moving stacking member associated to the removable module, in which the recycling container includes a pressing element for the stack of banknotes, a taking gear and motion conversion and transmission elements between the taking gear and the pressing element, and in which said taking gear is engageable with the moving stacking member, at assembled container and in the operative position of the respective module.

12. Equipment according to claim 11, characterized in that the modules are arranged in relationship of vertical superimposition, in which the store safe has an opening with a door in a conventionally frontal section, and in which said moving member is arranged in a rear portion of the store safe.

13. Equipment according to claim 1, characterized in that the banknotes of the stack have support on a longer edge and in that the insertion and extraction device includes a separation member between an output area of the banknotes and the stack of banknotes for facilitating the introduction of the banknotes, and a separation roller for the extraction of the banknotes from the terminal surface of the stack, and in which said separation member comprises two insertion spirals for banknotes arranged side by side and extended in the sense of the stacking for the insertion of the banknotes on a terminal surface of the stack.

14. Removable module according to claim 1, characterized in that the recycling container defines an area of access to a terminal surface of the stack of banknotes and includes an element of opening-closing for said area of access and an access-command mechanism for the element of opening-closing, said module comprising an actuating device for the access-command mechanism, while said actuating device being provided for operating on the access-command mechanism, when the container is assembled with the module, so as to arrange the element of opening-closing in an open position, of access to the stack of banknotes.

15. Equipment according to the claim 1 characterized in that the removable module comprises a frame coupable with the recycling container, and in which said frame has possibility of shifting between an acceptance position and an operative position, the acceptance position being arranged for receiving the recycling container in a pre-assembling phase, and the operative position being provided for the condition in which the container is assembled with the insertion and extraction device.

16. Removable module according to claim 15, characterized in that it comprises a manual shifting member for said frame, operative for completing the assemblying of the recycling container with the respective removable module.

17. Removable module according to claim 14 characterized in that the access-command mechanism includes command elements projecting from slots of the container, the shifting of the container by means of the frame causing the command elements to shift with respect to the container for the arrangement of the opening-closing element in an open position.

18. Equipment for the deposit and the automatic withdrawal of banknotes comprising a store safe with a series of banknote receipting and dispensing modules, a store transport mechanism for moving the banknotes from the modules and toward said modules and in which the banknote receipting and dispensing modules are arranged overlapped in the store safe, with individual slide capability, for service, on substantially horizontal slide surfaces, said modules comprising each one a banknote collecting seat as a stack with arrangement in vertical and an insertion and extraction device; said equipment being characterized in that the transport mechanism has a substantially vertical path and comprises diverting members which define paths of insertion and extraction for the banknotes, in which said transport mechanism includes sections associated with the single modules with possibility of individual opening and closing, and in which the sections associated of the transport mechanism are mounted on the modules and move, for service, together with said modules.

19. Banknote receipting and dispensing module mountable on an equipment for the deposit and the withdrawal of banknotes, the said module including an insertion and extraction device for banknotes and a base structure and being characterized in that it comprises a recycling container for the banknotes; in which said container is manually mountable and detachable with respect to the base structure, with vertical arrangement of the banknotes and support on a longer edge and formation of a stack of banknotes; the recycling container being removable and assemblable with respect to the base structure and the insertion and extraction device, in an position of the module external to the equipment.

20. Removable module according to claim 19, characterized in that the recycling container defines an area of access to a terminal surface of the stack of banknotes and includes an element of opening-closing for the area of access and a command-access mechanism for the element of opening-closing; said module including an element or elements of actuation and/or control, operative on the command access mechanism, so as to cause the area of access to be opened in association with the mounting of the container on the base structure and cause the area of access to be closed in the condition of removed container.

21. Removable module according to claim 20, characterized in that said module comprises an element coupable with the recycling container, shiftable with respect to the base structure, and a manual shifting member arranged between said coupable element and the base structure; in which said coupable element is shiftable between an acceptance position and an operative position, and in which said manual shifting member is operative for completing the assemblying of the recycling container with the respective removable module; the acceptance position being provided for receiving the recycling container in a pre-assembling phase and the operative position being associated with the condition in which the container is assembled with the insertion and extraction device.

22. Receipting and dispensing module for an equipment of automatic deposit and withdrawal of banknotes, said module including an insertion and extraction device for banknotes and being characterized in that it comprises a base structure and a recycling container for the banknotes with vertical arrangement, support on a longer edge and formation of a stack, and in which said container is manually mountable and removable with respect to the base structure; and
in which the recycling container defines an area of access to the stack of banknotes and includes an opening-closing element for said area of access and a command mechanism for the opening-closing element;
the area of access to the stack of banknotes being functional to the insertion and extraction device, for inserting and extracting the banknotes relatively to a terminal surface of the stack, when the container is mounted in the base structure; and
said module including an actuating and/or control element or elements, operative on the command mechanism for the opening-closing element such to cause the area of access to be opened in association with the mounting of the container in the base structure and to cause said area to be closed in condition of removed container.

23. Removable module according to claim 22, characterized in that it comprises an assembling device, actuatable for moving the container with respect to the base structure between a condition of disengagement for the pre-assembling or the removal of the container and an operative condition of engagement of the insertion and extraction device with the terminal surface of the stack of banknotes.

24. Removable module according to claim 22, characterized in that said container includes a key mechanism for the mounting in the module, and for the locking after removal from the module, and in that the element or the elements of actuating and/or control of the module are operative on the command mechanism to open the opening-closing element at the mounting moment in the case of a mounting presetting, said key mechanism preventing the container to be mounted in the said module in the locking condition after removal.

25. Container or cartridge of deposit banknotes for an equipment of automatic processing of banknotes comprising a series of banknote receipting and dispensing modules, and in which said container supports the banknotes as a stack with vertical arrangement and support on a longer edge and has recycling function, the said container being characterized in that it defines an area of access to the stack of banknotes, and includes a keeping element for said stack adjacent to the area of access and an element of opening-closing for said area, in which
said container is removably installable in an banknote receipting and dispensing module including a base structure, an insertion and extraction banknotes device and an actuation element or actuation elements for the keeping element and/or for said opening-closing element; and in which
the opening-closing element closes said area of access in the condition of removed container, and it is opened under the action of the actuation element or the actuation elements at the moment of the mounting in the module;
said area being predisposed, in condition of mounted container, for allowing to the insertion and extraction device to engage a terminal surface of the stack in function of stacking and separation of the banknotes.

26. Recycling container according to claim 25, characterized in that it comprises a pressing element for pushing the stack of banknotes toward the area of access, a bottom with a pair of belts of base which extend through the space provided for the stack and having each one a higher branch of support for the stack of banknotes, lateral transport belts of shifting for the pressing element, synchronous with the belts of base and which also extend through the space provided for the stack, a motion taking element common to said belts and locking elements for locking the pressing element, when in non-operative condition.

27. Recycling container according to claim 25 characterized in that it defines an upper opening of access to said stack, for the manual loading and emptying of the banknotes, a cover for said opening and a lock group of locking for said cover and in which a locking-unlocking mechanism for said opening-closing element and a mechanism of connection between the lock group and the locking-unlocking mechanism are provided for actuating said locking-unlocking mechanism together with the lock group at the moment of closing of the cover.
